(19) United States
(12) Patent Application Publication
(10) Pub. No.: US 2007/0112516 A1
(43) Pub. Date: May 17, 2007

(54) Apparatus for reducing impact of vehicle crash

(75) Inventor: Shinji Taniguchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/430,245

(22) Filed: May 9, 2006

(30) Foreign Application Priority Data
Nov. 15, 2005 (JP) 2005-330179

(51) Int. Cl. G08G 1/16

(52) U.S. Cl. 701/301; 340/903; 340/436

(57) ABSTRACT

An apparatus includes: an obstacle detecting unit for detecting a relative distance and a relative speed of an obstacle; a crash judgment unit for determining whether or not the driver's own vehicle will crash against the obstacle; and an obstacle handling device for reducing an impact caused at a time of a crash against the obstacle when the crash judgment unit has judged that the driver's own vehicle will crash against the obstacle. The crash judgment unit makes a crash judgment according to a limit distance enabling avoidance of the crash only through braking, when the obstacle detecting unit has detected a first obstacle in an area in front of the driver's own vehicle and a second obstacle in an area that is supposed to be entered by the driver's own vehicle afterward as a result of a steering operation for avoiding a crash against the first obstacle.

### BACKGROUND OF THE INVENTION

1. Field of the Invention

The present invention relates to an apparatus for reducing an impact of a vehicle crash, which detects an obstacle located in front of a running vehicle to reduce an impact caused to a passenger by, for example, retracting a seat belt when a crash is likely to occur.

2. Description of the Related Art

Conventionally, there have been proposed various methods for detecting an obstacle located in front of a driver's own vehicle (hereinafter referred to as “own vehicle”) to issue a warning to the driver or to perform deceleration control for the purpose of lessening a damage caused as a result of a crash of the own vehicle against the obstacle located in front thereof (herein after referred to as “obstacle”). Also, there is proposed a method of detecting an object located in front of the own vehicle by means of a laser radar, an radio wave radar, or the like, determining from a positional relationship between the own vehicle and the object whether a crash against the object is avoidable through steering or through braking, and calculating a risk of contact with the object (e.g., see “Guideline on Practical Application of Braking Apparatus for Reducing Impact of Crash against Front Obstacle to ASV” published by Investigative Commission of Promotion of Advanced Safety Vehicle Promotion at Ministry of Land, Infrastructure and Transport in December, 2002). The warning is issued or speed control is performed based on the calculated risk of contact with the object. Thus, an accurate determination on the risk of contact between the own vehicle and the object is made, thereby being capable of preventing the occurrence of such contact.

Further, assuming that an area that is supposed to be entered afterward by the own vehicle is a caution-needed area, when an obstacle is detected in the caution-needed area, a crash judgment against the obstacle is made based on a distance between the own vehicle and the obstacle and a relative speed therebetween (e.g., see JP 2004-38245 A).

In the conventional braking apparatus for reducing the impact of the crash against the obstacle as described above, the obstacle is detected, a braking-based avoidance limit distance and a steering-based avoidance limit distance are determined based on a relative speed and a relative distance with respect to the obstacle, the smaller one of the braking-based avoidance limit distance and the steering-based avoidance limit distance is chosen as a crash avoidance limit distance, and then a crash avoidance operation such as the issuance of the warning or automatic braking is performed.

In the conventional apparatus for detecting the obstacle to the vehicle as described above, all the areas that are supposed to be entered as caution-needed areas by the vehicle in consideration of a moving condition thereof are assumed, and makes a crash judgment against the obstacle based on a relative speed and a relative distance with respect to the obstacle when the obstacle is detected in any one of those caution-needed areas.

In each of the conventional apparatuses, there is a problem in that a crash judgment using a crash judging line calculated from a steering-based avoidance limit distance does not make it easy to avoid the crash through braking when it is difficult to avoid the crash through steering, that is, in a situation where an obstacle is located in front of a own vehicle and the width of a road sandwiched between guardrails, etc. is narrow, or when it is impossible to avoid the crash through steering, for example, in a situation where the road is completely blocked up while a braking-based avoidance limit distance is larger than the steering-based avoidance limit distance. In addition, there is also a problem in that a secondary disaster may occur if the crash is avoided through steering.

### SUMMARY OF THE INVENTION

The present invention has been made to solve the above-mentioned problems. It is an object of the present invention to obtain an apparatus for reducing an impact of a vehicle crash, which can enhance accuracy of a crash judgment so as to reduce the impact of the crash by determining in advance that an attempt to avoid the crash through steering is dangerous and thus making a crash judgment only by braking without taking into account a condition for avoiding the crash through steering.

According to the present invention, there is provided an apparatus for reducing an impact of a vehicle crash, including: obstacle detecting means for detecting an obstacle located in front of a own vehicle and detecting a relative distance and a relative speed of the obstacle; crash judgment means for determining whether or not the own vehicle will crash against the obstacle detected by the obstacle detecting means; and an obstacle handling device for reducing an impact caused at a time of a crash against the obstacle when the crash judgment means has judged that the own vehicle will crash against the obstacle. In the apparatus, the crash judgment means makes a crash judgment according to a limit distance enabling avoidance of the crash only through braking, when the obstacle detecting means has detected a first obstacle in an area in front of the own vehicle and a second obstacle in an area that is supposed to be entered by the own vehicle afterward as a result of a steering operation for avoiding a crash against the first obstacle.

The apparatus for reducing an impact of a vehicle crash according to the present invention achieves an effect of making it possible to enhance the accuracy of a crash judgment so as to reduce the impact of the crash by judging in advance that an attempt to avoid the crash through steering is dangerous and thus making a crash judgment only by braking without taking into account a condition for avoiding the crash through steering.

### BRIEF DESCRIPTION OF THE DRAWINGS

In the accompanying drawings:

FIG. 1 is a block diagram showing a configuration of an apparatus for reducing an impact of a vehicle crash according to a first embodiment of the present invention;

FIG. 2 is a view for illustrating an operation of the apparatus for reducing an impact of a vehicle crash according to the first embodiment of the present invention;

FIG. 3 is a graph showing a crash judging line of the apparatus for reducing an impact of a vehicle crash according to the first embodiment of the present invention; and

FIG. 4 is a block diagram showing a configuration of an apparatus for reducing an impact of a vehicle crash according to a second embodiment of the present invention.

### DETAILED DESCRIPTION OF THE PREFERRED EMBODIMENTS

### First Embodiment

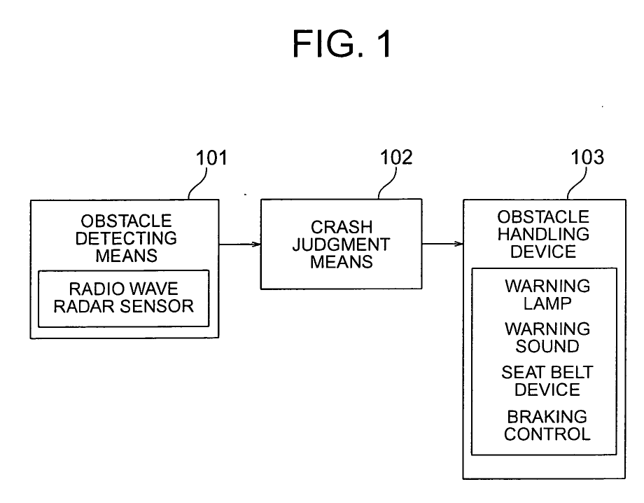

An apparatus for reducing an impact of a vehicle crash according to a first embodiment of the present invention will be described with reference to FIGS. 1 to 3. FIG. 1 is a block diagram showing a configuration of the apparatus for reducing an impact of a vehicle crash according to the first embodiment of the present invention. It should be noted herein that like reference numerals denote like or corresponding components of FIGS. 1 to 4.

Referring to FIG. 1, the apparatus for reducing an impact of a vehicle crash, which is mounted in a vehicle, is equipped with the obstacle detecting means 101, the crash judgment means 102, and the obstacle handling device 103. The obstacle detecting means 101 is, for example, an radio wave radar sensor for detecting a relative distance and a relative speed of an obstacle located in front of the vehicle. The crash judgment means 102 makes a crash judgment of a own vehicle against the obstacle located in front of the vehicle, which has been detected by the obstacle detecting means 101. The obstacle handling device 103 is a mechanism for reducing an impact caused at the time of the crash against the obstacle (e.g., a warning lamp, a warning sound generating device, a seat belt device, a braking control device, and the like).

The obstacle detecting means 101 corresponds to a radar device for detecting an obstacle through reflection of laser beams, a radar device for detecting an obstacle through reflection of radio waves, an imaging device for detecting an obstacle by means of an image pickup element, and the like. The radar device for detecting an obstacle through reflection of laser beams can accurately detect a vehicle which may be a potential obstacle. The radar device for detecting an obstacle through reflection of radio waves can perform accurate detection even in the case of bad weather such as rain or fog. Furthermore, the imaging device for detecting an obstacle by means of the image pickup element can accurately detect a width of the obstacle.

The crash judgment means 102 is realized by software operating on a CPU.

The obstacle handling device 103 includes, for example, a motorized seat belt device capable of adjusting a tensile force applied to a seat belt when a passenger has the seat belt on. The seat belt device is equipped with belt adjusting means for adjusting a tensile force applied to the seat belt to a larger value as the risk of a crash judged by the crash judgment means 102 increases, thereby making it possible to reduce an impact caused at the time of the crash.

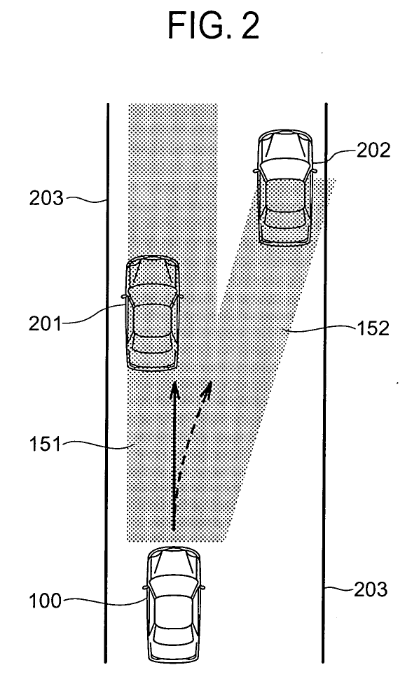

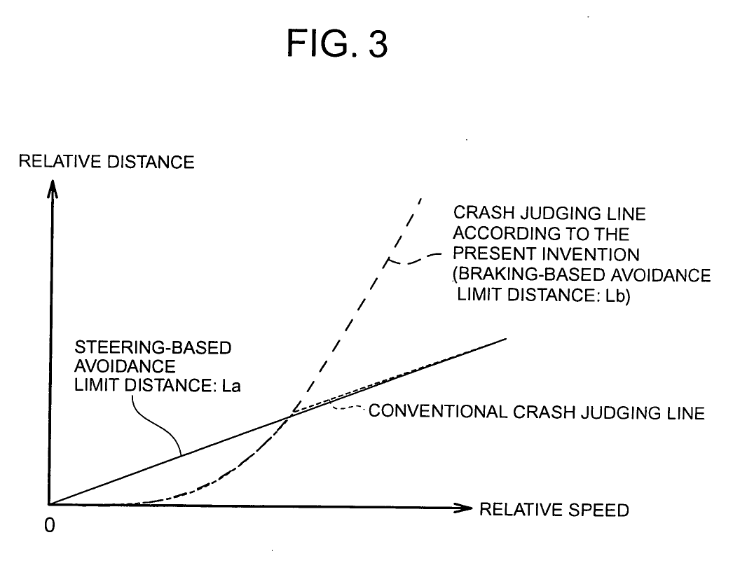

Next, the operation of the apparatus for reducing an impact of a vehicle crash according to the first embodiment of the present invention will be described with reference to FIGS. 2 and 3. FIG. 2 is a view for illustrating an operation of the apparatus for reducing an impact of a vehicle crash according to the first embodiment of the present invention. FIG. 3 is a graph showing a crash judging line of the apparatus for reducing an impact of a vehicle crash according to the first embodiment of the present invention.

According to a situation simulated in FIG. 2, guardrails 203 are provided on both sides of a two-lane road, and a own vehicle 100 and an obstacle 201 such as a running vehicle are located on the driver's own lane, which is a running lane while an obstacle 202 such as a running vehicle is located on a lane other than the driver's own lane, which is an overtaking lane. A lane determining area 151 used in making a crash judgment and a predicted lane determining area 152 used in avoiding a crash through steering are also shown in FIG. 2.

Referring to FIG. 3, an axis of ordinate represents a relative distance between the own vehicle and the obstacle, and an axis of abscissa represents a relative speed of the own vehicle with respect to the obstacle. A straight line (solid line) represents a steering-based avoidance limit distance (La). A curve (thick broken line) represents a crash judging line (braking-based avoidance limit distance: Lb) according to the present invention. A thin broken line represents a conventional crash determining line.

In a conventional apparatus, a relative speed and a relative distance are detected as to objects detectable by obstacle detecting means, and a steering-based avoidance limit distance La and a braking-based avoidance limit distance Lb as shown in FIG. 3 are calculated as to that one of the obstacles which carries the highest risk of a crash. A warning is issued, automatic braking is performed, or other measures are taken as to those of the obstacles in which the relative distance is smaller than both the steering-based avoidance limit distance La and the braking-based avoidance limit distance Lb.

The “steering-based avoidance limit distance” herein means a longitudinal distance calculated as a physical limit required for avoidance of a crash against an obstacle through steering. The “braking-based avoidance limit distance” herein means a longitudinal distance calculated as a physical avoidance limit required for avoidance of a crash against an obstacle through braking.

As shown in FIG. 3, the steering-based avoidance limit distance and the braking-based avoidance limit distance can be expressed by the straight line La and the curve Lb, respectively. In addition, a curve Li, which is obtained by sequentially plotting the smaller one of values indicated by the straight line La and the curve Lb, is defined as a crash avoidance limit distance and used as a crash judging line.

The straight line La, the curve Lb, and the curve Li are calculated from the following equations [1], [2], and [3], respectively.
La=T_{TTC}×Vr [1]

In the equation [1], T_{TTC} represents a crash predicted time (sec), and Vr represents a relative speed (m/s).
Lb=Vr²/(2×A) [2]

In the equation [2], A represents a maximum deceleration (m/s²) of the own vehicle.
Li=min(Lb, La) [3]

The “crash predicted time” in the equation [1] is a time it takes until the own vehicle crashes against the obstacle on the assumption that the relative speed between the own vehicle and the obstacle remains unchanged. The “maximum deceleration of the own vehicle” in the equation [2] is an average deceleration calculated from the shortest braking distances of respective types of vehicles.

In a situation where a crash is substantially unavoidable through steering as shown in FIG. 2, that is, in a situation where a crash against the obstacle 201 is avoidable but a crash against the obstacle 202, which is located in front of the own vehicle that has just avoided a crash against the obstacle 202, is unavoidable, the own vehicle cannot avoid the crash against the obstacle 202 even if the crash against the obstacle 201 has been successfully avoided by issuing a warning or performing automatic braking at the steering-based avoidance limit distance La, that is, at the distance calculated according to the equation [1]. To over come this drawback, according to the first embodiment of the present invention, a crash judgment is made with the obstacle 202 taken into account in advance, using Li in the equation [3] with the determining condition expressed by the equation [1] excluded, that is, the braking-based avoidance limit distance Lb in the equation [2]. Therefore, the accuracy in avoiding a crash is enhanced.

That is, the obstacle detecting means 101 detects the obstacle 201 in the lane determining area 151, and the obstacle 202 in the predicted lane determining area 152. The obstacle detecting means 101 also detects a relative distance and a relative speed of the obstacle 201, and a relative distance and a relative speed of the obstacle 202.

The crash judgment means 102 makes a crash judgment according to the braking-based avoidance limit distance Lb, which enables avoidance of a crash only through braking, when the obstacle detecting means 101 has detected the obstacle 201 in the lane determining area 151 and the obstacle 202 in the predicted lane determining area 152. The crash judgment means 102 calculates the braking-based avoidance limit distance Lb of the obstacle 201 in front of the own vehicle from the relative speed of the obstacle 201 calculated by the obstacle detecting means 101. The crash judgment means 102 compares the relative distance of the obstacle 201 calculated by the obstacle detecting means 101 with the braking-based avoidance limit distance Lb obtained through calculation, and then makes a crash judgment. In other words, the crash judgment means 102 judges that the own vehicle will crash against the obstacle 201 located in front thereof when the relative distance of the obstacle 201 has become smaller than the braking-based avoidance limit distance Lb, and transmits this information on the occurrence of the crash to the obstacle handling device 103. Immediately before the relative distance of the obstacle 201 approaches the braking-based avoidance limit distance Lb, the crash judgment means 102 transmits to the obstacle handling device 103 information on a situation immediately before the occurrence of a crash by advising the obstacle handling device 103 that the own vehicle is approaching a point at the braking-based avoidance limit distance Lb from the obstacle 201 located in front thereof.

After having received the information on the situation immediately before the occurrence of the crash from the crash judgment means 102, the obstacle handling device 103 issues a warning to the passenger by means of a warning lamp or a warning sound generating device, and attempts to perform braking by actuating a braking control device. Then, after having received the information on the occurrence of the crash from the crash judgment means 102, the obstacle handling device 103 reduces an impact of the crash against the obstacle 201 by actuating the seat belt device, that is, by increasing a tensile force applied to the seat belt.

The apparatus for reducing an impact of a vehicle crash according to the first embodiment of the present invention is equipped with the obstacle detecting means 101, the crash judgment means 102, and the obstacle handling device 103. The obstacle detecting means 101 detects an obstacle located in front of the own vehicle and detects a relative distance and a relative speed of the obstacle. The crash judgment means 102 makes a crash judgment of the own vehicle against the obstacle detected by the obstacle detecting means 101. The obstacle handling device 103 issues a warning for urging the driver to avoid the obstacle based on the information on the situation immediately before the occurrence of the crash or the information on the occurrence of the crash, which has been transmitted from the crash judgment means 102, and also reduces an impact caused at the time of the crash against the obstacle. When there is further obstacle detected in an area which is supposed to be entered by the own vehicle afterward through a steering-based avoidance operation, the crash judgment means 102 makes a crash judgment against that obstacle according to a braking-based avoidance limit distance, which enables avoidance of a crash only through braking.

According to the first embodiment of the present invention, a warning is issued or automatic braking is performed only according to a braking-based avoidance limit distance when it is difficult to avoid a crash through steering, that is, in a situation where the obstacle 201 is located in front of the own vehicle and the width of a road sandwiched between the guardrails 203, etc. Is narrow, or when it is impossible to avoid the crash through steering, for example, in a situation where the road is completely blocked up. Therefore, it is possible to avoid the crash.

The tensile force applied to the seat belt of the seat belt device is increased through automatic adjustment as the risk of a crash judged by the crash judgment means 102 is higher, and the driver is warned to avoid a crash against an obstacle. As a result, it is possible to reduce an impact caused at the time of the crash against the obstacle.

According to the first embodiment of the present invention, a crash judgment is made according to the braking-based avoidance limit distance Lb, which enables avoidance of a crash through braking, when it is virtually impossible to avoid the crash through steering. Thus, the accuracy of a crash judgment is enhanced.

### Second Embodiment

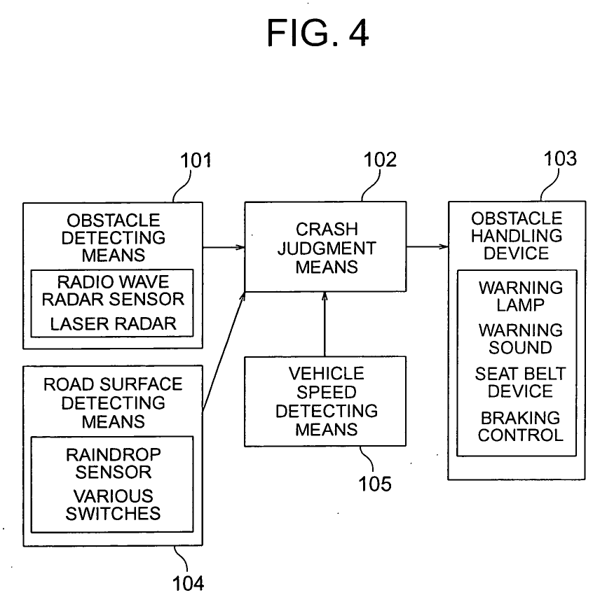

An apparatus for reducing an impact of a vehicle crash according to a second embodiment of the present invention will be described with reference to FIG. 4. FIG. 4 is a block diagram showing a configuration of the apparatus for reducing an impact of a vehicle crash according to the second embodiment of the present invention.

Referring to FIG. 4, the apparatus for reducing an impact of a vehicle crash, which is mounted in a vehicle, is equipped with the obstacle detecting means 101, the crash judgment means 102, the obstacle handling device 103, road surface detecting means 104, and vehicle speed detecting means 105. The obstacle detecting means 101 is, for example, an radio wave radar sensor or a laser radar for detecting a relative distance and a relative speed of an obstacle located in front of the vehicle. The crash judgment means 102 makes a crash judgment against the obstacle located in front of the vehicle, which has been detected by the obstacle detecting means 101. The obstacle handling device 103 is a mechanism for reducing an impact caused at the time of the crash against the obstacle (e.g., a warning lamp, a warning sound generating device, a seat belt device, a braking control device, and the like). The road surface detecting means 104 is composed of a raindrop sensor and various switches including a wiper switch and a light switch for a head lamp.

Next, the operation of the apparatus for reducing an impact of a vehicle crash according to the second embodiment of the present invention will be described with reference to FIG. 4.

According to the second embodiment of the present invention, in addition to the contents of the first embodiment of the present invention, the condition of a road surface and the running speed of a own vehicle are additionally taken into account in making a crash judgment in order to enhance the accuracy of the determination.

The road surface detecting means 104 detects an environmental condition of a road surface. The crash judgment means 102 increases the braking-based avoidance limit distance Lb based on the environmental condition of the road surface detected by the road surface detecting means 104. As regards the environmental condition of the road surface, the braking distance increases at the time of braking, for example, during rainy weather. Thus, the crash judgment means 102 makes a correction to increase the braking-based avoidance limit distance Lb.

Although a raindrop sensor may be used for directly detecting rain or the like as the road surface detecting means 104 for detecting the condition of a road surface, a wiper switch or the like may be employed instead. When the wiper switch is turned ON, the crash judgment means 102 makes a correction to increase the braking-based avoidance limit distance Lb.

The crash judgment means 102 may make a correction to increase the braking-based avoidance limit distance Lb not only during rainy weather but also in the nighttime. For instance, if a light switch for a head lamp is employed as the road surface detecting means 104, the crash judgment means 102 makes a correction to increase the braking-based avoidance limit distance Lb when the light switch is turned ON.

In the second embodiment of the present invention, a running speed of the own vehicle 100 is detected, so the braking-based avoidance limit distance Lb, which allows the own vehicle 100 to avoid a crash through braking, can be determined by the running speed. In other words, the distance enabling avoidance of a crash through braking is increased as the running speed of the own vehicle 100 rises. Therefore, when the crash judgment means 102 increases the braking-based avoidance limit distance Lb as the running speed of the own vehicle 100 rises, an erroneous warning or a malfunction can be prevented. As a result, the accuracy of a crash judgment is enhanced.

In the second embodiment of the present invention, the road surface detecting means 104 for detecting an environmental condition of a road surface is provided, and the crash judgment means 102 increases a limit distance enabling avoidance of a crash in response to a deterioration of the road condition. Consequently, the accuracy of a crash judgment is enhanced. The occurrence of an accident can be prevented by coping with the environmental condition of the road surface (low visibility, a change in braking distance, and the like) to change, for example, the crash judging line so as to ensure actuation preceding a conventional predicted time point of a crash according to the condition of the road surface at the time of rainfall, and cope with an increase in braking distance resulting from slippage.

In the second embodiment of the present invention, the vehicle speed detecting means 105 for detecting a vehicle speed is provided, and the crash judgment means 102 increases a distance enabling avoidance of a crash through braking from the standpoint of kinetic performance, as a result of a rise in vehicle speed. Thus, it is possible to reduce the risk of an erroneous warning or a malfunction by increasing the braking-based avoidance limit distance Lb.

What is claimed is:

1. An apparatus for reducing an impact of a vehicle crash, comprising:
obstacle detecting means for detecting an obstacle located in front of a driver's own vehicle and detecting a relative distance and a relative speed of the obstacle;
crash judgment means for judging whether or not the driver's own vehicle will crash against the obstacle detected by the obstacle detecting means; and
an obstacle handling device for reducing an impact caused at a time of a crash against the obstacle when the crash judgment means has judged that the driver's own vehicle will crash against the obstacle,
wherein the crash judgment means makes a crash judgment according to a limit distance enabling avoidance of the crash only through braking, when the obstacle detecting means has detected a first obstacle in an area in front of the driver's own vehicle and a second obstacle in an area that is supposed to be entered by the driver's own vehicle afterward as a result of a steering operation for avoiding a crash against the first obstacle.

2. An apparatus for reducing an impact of a vehicle crash according to claim 1, further comprising road surface detecting means for detecting an environmental condition of a road surface,
wherein the crash judgment means increases the limit distance based on the environmental condition of the road surface detected by the road surface detecting means.

3. An apparatus for reducing an impact of a vehicle crash according to claim 1, further comprising vehicle speed detecting means for detecting a running speed of the driver's own vehicle,
wherein the crash judgment means increases the limit distance when the running speed of the driver's own vehicle detected by the vehicle speed detecting means has risen.

4. An apparatus for reducing an impact of a vehicle crash according to claim 1, wherein the obstacle handling device is a motorized seat belt device capable of adjusting a tensile force applied to a seat belt when a passenger has the seat belt on.

5. An apparatus for reducing an impact of a vehicle crash according to claim 1, wherein the obstacle detecting means is a radar device for detecting an obstacle through reflection of laser beams.

6. An apparatus for reducing an impact of a vehicle crash according to claim 1, wherein the obstacle detecting means is a radar device for detecting an obstacle through reflection of radio waves.

7. An apparatus for reducing an impact of a vehicle crash according to claim 1, wherein the obstacle detecting means is an imaging device for detecting an obstacle by using an image pickup element.

8. An apparatus for reducing an impact of a vehicle crash according to claim 2, further comprising vehicle speed detecting means for detecting a running speed of the driver's own vehicle,
wherein the crash judgment means increases the limit distance when the running speed of the driver's own vehicle detected by the vehicle speed detecting means has risen.

9. An apparatus for reducing an impact of a vehicle crash according to claim 2, wherein the obstacle handling device is a motorized seat belt device capable of adjusting a tensile force applied to a seat belt when a passenger has the seat belt on.

10. An apparatus for reducing an impact of a vehicle crash according to claim 3, wherein the obstacle handling device is a motorized seat belt device capable of adjusting a tensile force applied to a seat belt when a passenger has the seat belt on.

11. An apparatus for reducing an impact of a vehicle crash according to claim 2, wherein the obstacle detecting means is a radar device for detecting an obstacle through reflection of laser beams.

12. An apparatus for reducing an impact of a vehicle crash according to claim 3, wherein the obstacle detecting means is a radar device for detecting an obstacle through reflection of laser beams.

13. An apparatus for reducing an impact of a vehicle crash according to claim 4, wherein the obstacle detecting means is a radar device for detecting an obstacle through reflection of laser beams.

14. An apparatus for reducing an impact of a vehicle crash according to claim 2, wherein the obstacle detecting means is a radar device for detecting an obstacle through reflection of radio waves.

15. An apparatus for reducing an impact of a vehicle crash according to claim 3, wherein the obstacle detecting means is a radar device for detecting an obstacle through reflection of radio waves.

16. An apparatus for reducing an impact of a vehicle crash according to claim 4, wherein the obstacle detecting means is a radar device for detecting an obstacle through reflection of radio waves.

17. An apparatus for reducing an impact of a vehicle crash according to claim 2, wherein the obstacle detecting means is an imaging device for detecting an obstacle by using an image pickup element.

18. An apparatus for reducing an impact of a vehicle crash according to claim 3, wherein the obstacle detecting means is an imaging device for detecting an obstacle by using an image pickup element.

19. An apparatus for reducing an impact of a vehicle crash according to claim 4, wherein the obstacle detecting means is an imaging device for detecting an obstacle by using an image pickup element.
